(19) United States
(12) Patent Application Publication
(10) Pub. No.: US 2010/0131642 A1
(43) Pub. Date: May 27, 2010

(54) SYSTEM FOR MONITORING THE USE OF CONTENT IN A VEHICLE

(75) Inventors: George Chalikouras, Melbourne (AU); Rohan Beresford Femando, Mitcham (AU); Christopher John Wilson, Melbourne (AU); Richard Race Biggins, Melbourne (AU); Davd Alan Hoyle, Melbourne (AU); Brent Anthony Stafford, Melbourne (AU)

Correspondence Address: SEED INTELLECTUAL PROPERTY LAW GROUP PLLC, 701 FIFTH AVE, SUITE 5400, SEATTLE, WA, 98104, US

(73) Assignee: Metrometrix Pty Ltd., Melbourne (AU)

(21) Appl. No.: 12/596,173

(22) PCT Filed: Apr. 17, 2008
(86) PCT No.: PCT/AU08/00541

§ 371 Date: Dec. 30, 2009

Related U.S. Application Data
(60) Provisional application No. 60/907,773, filed on Apr. 17, 2007.

(51) Int. Cl. G06F 15/173; G06Q 30/00

(52) U.S. Cl. 709/224; 705/14.4

(57) ABSTRACT

A content monitoring system having a vehicle content module for monitoring the use of a content player in a vehicle. The vehicle module includes an interface to a data communications network of the vehicle and a data collector for monitoring data on the data communications network to access in real time player data representing use of the player. The content can include self-loaded content, such as that of a CD, DVD, an ipod, and an mp3 file and broadcast content, such as that of an FM radio broadcast. The content monitoring system also includes a transmission module for transmitting the player data from the vehicle and a server system including an analysis module for receiving and processing the player data from the data collector to generate content usage report data, e.g. representing an audience or ratings survey.

### FIELD

The present invention relates to a system for monitoring the use of content in a vehicle, and in particular a system that may be used to provide real-time data concerning use of a content player, such as a car radio.

### BACKGROUND

Content providers, e.g. vendors and broadcasters of content, frequently include marketing messages in their content: for example, radio stations broadcast audio advertisements, TV stations include TV “spots”, podcasters insert audio or video messages, and movies include product placements. The value to an advertiser of placing a marketing message (and thus the fee the vendor can charge for including the marketing message) depends on the number and type of consumers who receive the message. For example, an advertiser may pay to have an advertisement included in content depending on the number of users within a selected demographic who see or hear the advertisement. Unfortunately, it is difficult to determine when and where any given marketing message has been delivered, particularly for freely available (or widely available) content.

The content providers may also wish to determine audience reaction to their actual content, rather than simply the embedded marketing messages; such an audience reaction provides a measure of the popularity or desirability of the content to users/viewers in general, or to users in one or more certain demographics. This information may be used to determine which content is most popular (e.g. for a publicly funded broadcaster, or for estimating the popularity of certain songs on the radio).

Existing methods for generating estimates of use of content (i.e. receiving, listening or watching) include audience ratings and surveys, such as a log book (filled in by a user), or a set-top box monitor (to record which channel is being displayed on the user's television).

These methods require a substantial amount of user interaction (e.g. filling out survey forms), or expensive specialised hardware (e.g. set-top boxes), or slow and costly data entry and processing (e.g. collecting and scanning survey forms). Existing methods may rely on off-line analysis of the monitored data to provide usage reports to third parties, such as vendors and broadcasters, thus there may be a considerable delay between the time when the content is used and when corresponding survey data is available.

It is desirable to address one or more of the above described problems, or at least provide a useful alternative.

### SUMMARY

In accordance with the present invention there is provided a content monitoring system for monitoring the use of a user interface in a vehicle having a data communications network, including:
an interface for communicating with the data communications network; and
a monitoring module for collecting content usage data, associated with use of the user interface, in real time from the data communications network.

The present invention also provides a vehicle content module for controlling and monitoring a user interface in a vehicle having a data communications network, including:
a gateway interface for communicating with the data communications network; and
a collector for collecting usage data, relating to use of the user interface, in real time from the data communications network, using the gateway interface; and
a command generator for generating control data, relating to a command for the user interface, and sending the control data to the data communications network using the gateway interface.

The present invention also provides a vehicle module in a vehicle, including:
a gateway interface to a data communication network of the vehicle;
a monitoring module to obtain in real time usage data from the communications network representing use of a user interface of the vehicle; and
a transmission module for transmitting the usage date from the vehicle.

The present invention also provides a vehicle content module for monitoring the use of a content player in a vehicle, including:
a gateway interface to a data communications network of the vehicle; and
a data collector for monitoring data on the data communications network to access in real time player data representing use of the player.

The present invention also provides a content monitoring system including:
an analysis module for processing the player data, from a vehicle content module, to generate content usage report data.

The present invention also provides a content usage monitoring process performed on a vehicle, including:
monitoring bus data on a vehicle data bus of the vehicle;
extracting usage data from the bus data relating to content usage in the vehicle; and
storing the usage data with a time stamp.

### DESCRIPTION OF THE DRAWINGS

Preferred embodiments of the invention are further described, by way of example only, with reference to the accompanying drawings, which are not to scale, wherein:

FIG. 1 is a schematic diagram of a content control and monitoring system, including a vehicle content module and a server;

FIG. 2 is a hardware schematic of the vehicle content module in a vehicle;

FIG. 3 is a functional diagram of modules in the server;

FIG. 4 is a schematic diagram of a plurality of inter-connected vehicle content modules and servers;

FIG. 5 is a diagram of a software architecture of the vehicle content module; and

FIG. 6 is a flow chart of functions of the vehicle content module.

### DETAILED DESCRIPTION OF PREFERRED EMBODIMENTS

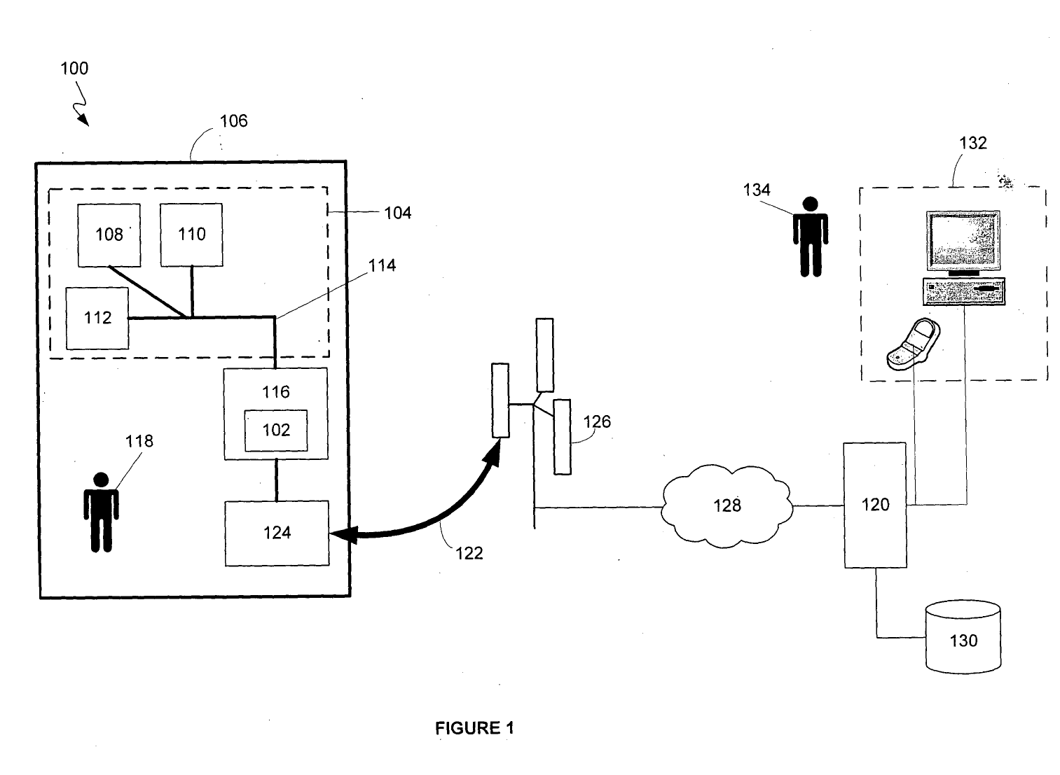

A content control and monitoring system 100, shown in FIG. 1, includes a vehicle content module 102 for monitoring, recording, storing and sending usage data relating to the use of user interfaces 104 in a vehicle 106. The user interfaces 104 include: content players in the form of media units 108 (e.g. cassette players, MP3 players, MP4 players, iPods and mobile entertainment devices, mini-disc players, DVD players, in-vehicle mobile telephones, in-vehicle PDAs, analog/digital/IP televisions, AM/FM radio, satellite radio, etc); an instrument cluster 110 (e.g. console information displays, body and engine management systems, safety systems, accelerator position detector, a GPS receiver, audible annunciators and warnings); and input units 112 (e.g. user settings on a radio or video front panel, or steering wheel panel, or an in-vehicle telephone, voice-command inputs, keypad inputs, joystick inputs). The monitored usage data includes settings and output signals of the user interfaces 104.

The user interfaces 104 are connected to the vehicle content module 102 via an in-vehicle data communications network in the form of a vehicle data bus 114. The vehicle data bus 114 is a transport-independent data communications network which operates in the vehicle 106 using a transport medium (e.g. conducting wire, optical fibre, wireless RF links, infrared links, audio links, ultra-sonic links, blue tooth links, etc.) and a pre-existing defined proprietary or publicly published communications protocol, e.g. a Controller Area Network (CAN) bus, a Local Intraconnect Network (LIN) bus, a Universal Asynchronous Receiver/Transmitter (UART) bus, a Media Oriented Systems Transport (MOST) bus, a Transmission Control Protocol (TCP) bus, a User Datagram Protocol (UDP) bus, or an Internet Protocol (IP) bus.

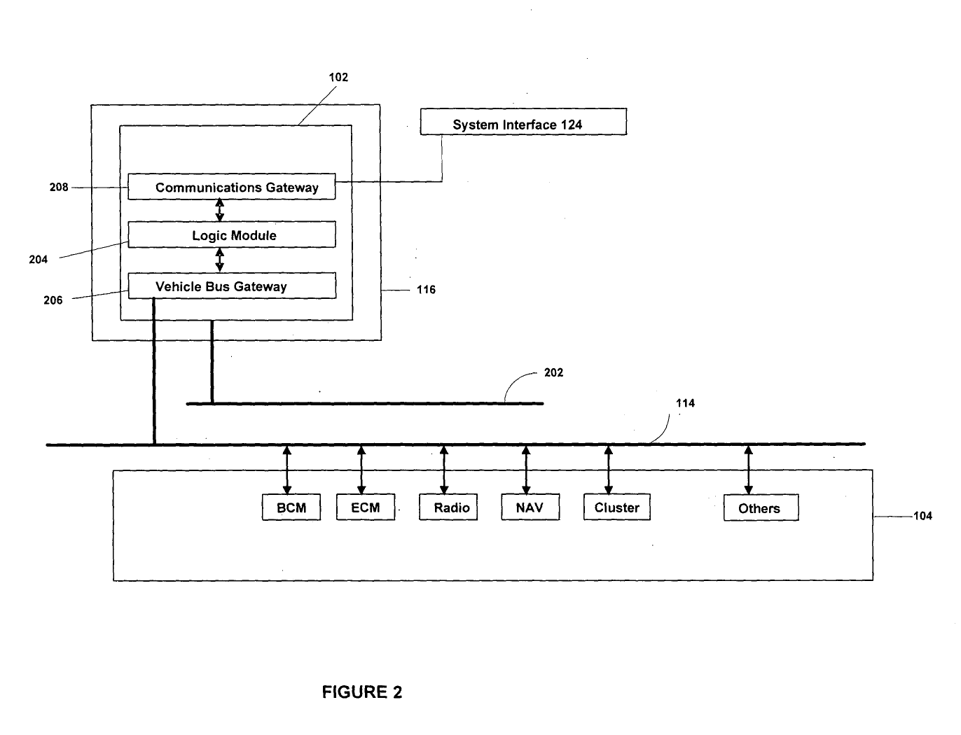

The vehicle content module 102 may be implemented using computer program code written in a computer language such as VB, C, C++, C#, Assembly Code or AT Commands, installed for execution on an in-car processor 116 (e.g. a pre-existing telematics processor, engine management system or customised installed hardware), connected to the vehicle data bus 114 and typically a vehicle power supply 202, as shown in FIG. 2. Alternatively, the vehicle content module 102 may be implemented in dedicated hardware, e.g. using Application Specific Integrated Circuit (ASIC) chips. The vehicle content module 102, as shown in FIG. 2, includes a logic module 204 for analysing and generating data, a vehicle bus gateway (VBG) 206 for communicating with the vehicle data bus 114, and a communications gateway 208 for communications exterior to the vehicle. The vehicle bus gateway 206 may be connected to the vehicle data bus 114 physically (by connecting conductor wire/s of the vehicle data bus 114 to the processor 116 of the vehicle 106), or (e.g. if a physical connection is not permitted due to warranty or regulatory issues) data on the vehicle data bus 114 is monitored using inductive or capacitive coupling.

In a passive mode, the vehicle content module 102 monitors and identifies data transmitted on the vehicle data bus 114. The vehicle content module 102 collects data representative of the use of the user interfaces 104 from the vehicle data bus 114 and stores this usage data in a series of individually time-stamped records.

In an active mode, the vehicle content module 102 also transmits data onto the vehicle data bus 114. In the active mode, the vehicle content module 102 interrogates the user interfaces 104 for relevant data. The vehicle content module 102 may transmit message data to an in-vehicle display, e.g. in the instrument cluster 110, requesting a response from a user 118 in the vehicle 106 (e.g. a driver or passenger). In another example, the vehicle content module 102 may transmit a command to a player to play a selected audio track or other content.

The vehicle content module 102 is in communication with a server system 120 (shown in FIG. 1) via a data link, which includes a wireless link 122 and a data network connection. The wireless link 122 includes a wireless transceiver 124 in the vehicle 106, in communication with the vehicle content module 102 (e.g. via the vehicle data bus 114), and an external wireless transceiver 126. The external wireless transceiver 126 is also in communication with the server 120 via the data network connection, which may include a protocol-independent data network 128 (e.g. the Internet) or propriety data connections. The wireless link 122 may be based on one of the following protocols: the Group Special Mobile (GSM), General Packet Radio Service (GPRS), Wireless Application Protocol (WAP), Code Division Multiple Access (CDMA), CDMA 2000 1X, CDMA 2000 1XEV-DO, Enhanced Data Rates GSM Evolution (EDGE), Wide Band CDMA (WCDMA), Universal Mobile Telecommunications Service (UMTS), Ultra Wide Band (UWB), Third Generation mobile/cellular (3G), High Speed Download Packet Access (HSDPA), Mobile Broadband Wireless Access (MBWA) 802.20, Dedicated Short Range Communication (DSRC), Vehicle Infrastructure Integration (VII), Continuous Air interface For Long and Medium distance (CAOM), NextG, Bluetooth, Zigbee Hotspots, Internet WiFi Hotspots, Wireless MAN, WiMax 802.16a, WiMax Mobile 802.16e, WiBro, etc. The vehicle content module 102 may also use communication capabilities of other manufacturers' vehicle modules if agreed by both parties, such as standardised telematics devices built into luxury vehicles at time of manufacture.

The usage data stored by the vehicle content module 102 is periodically buffered (in a data buffer) and transmitted to the server 120. If the wireless link 122 is not available, the vehicle content module 102 temporarily stores the data to be sent in the data buffer; when the wireless link 122 is again available, the complete contents of the data buffer is transmitted to the server 120 to be reconstructed in its correct time sequence. The usage data may also be stored by the vehicle content module 102 for a period of time (e.g. a month) in a digital memory (e.g. RAM, a hard drive or a removable USB drive). The digital memory may be accessed periodically via the wireless link 122. Alternatively, the digital memory may be physically removed and the usage data transmitted to the server 120 without using the in-vehicle wireless transceiver 124 (e.g. using email over the Internet).

The server 120 collates the usage data from one or more vehicle content modules 102 and stores this data in a database 130 in communication with the server 120.

The server 120 analyses the usage data, either in real time for data from the vehicle content module/s 102, or off-line using usage data from the database 130, to generate usage reports (e.g. information and listener statistics). The usage data is integrated or combined with other data for use in generating the reports. The other data includes data related to individual users 118 of vehicles 106 and data representing radio programming play lists and scheduling. This other data may be obtained from databases maintained by third parties, such as licensing authorities and broadcast stations.

The usage reports include summaries of content played on the user interfaces 104 and how the user 118 acted in response to the content. The usage reports are provided by report data transmitted from the server 120 to reporting devices 132 which may be viewed by an advertiser, broadcaster or vendor 134. The reporting devices 132 may include mobile telephones, personal digital assistants (PDAs), mobile/portable computers, smart clients such as ultra mobile PC's, fixed computers, and software information syndication services (e.g. Hitwise).

Advantageously, the report data is received by the reporting devices 132 on a continuous or semi-continuous basis as it is generated by the vehicle content module 102. Thus, an advertiser/broadcaster/vendor 134 has near real-time access to data indicating the use of user interfaces 104 in vehicles 106, including the content played and/or the responses of users 118. In this way, up-to-date decisions can be made regarding the media content transmitted to the users 118. For example, if a particular radio song is observed to be highly popular, the broadcaster may accordingly adjust the cost of advertising time directly following the song. In another example, an advertiser may decide to conduct a user survey (e.g. using the active mode of the content monitoring system 100) to gather more information if the vehicle content module 102 indicates a high usage of a particular DVD at a particular time.

In the active mode, the server 120 transmits data to the vehicle content module 102 via the wireless link 122. The data transmitted to the vehicle content module 102 from the server 120 is used to control, announce and display information within the vehicle 106, and optionally to retrieve a response to such information. For example, the server 120 may transmit a command to the vehicle content module 102 to display a question on a media unit 108 in the vehicle 106, where the question relates to a user survey (e.g. a radio announcer can ask the user 118 to select yes/no/maybe in response to a question); data generated by a corresponding response, e.g. on an in-vehicle input unit 112 such as Screen and Steering/Radio Controls, or on one of the media units 108 such as the radio or a Centre Information Display (e.g. a pixel matrix LCD information display located at the top of the centre console), or on the instrument cluster 110. The priority of the survey question is very low and may be disabled while the vehicle is in motion. In another example, the server 120 may transmit a command to the vehicle content module 102 to display a location-based message, for example a “McDonalds” advertisement can be flashed onto the dash display 100 meters before a vehicle reaches a “McDonalds” restaurant. Similarly, the message can advertise a “Myer” stock-take sale near a major “Myer” retail outlet. Pre-selected location-based advertising or reminder messages may also be generated for the user 118 (for example, the vehicle 106 may be low on fuel and the system 100 can indicate that a “Mobil” petrol station is 1 kilometre ahead on the left hand side). Localised traffic and weather messages may be played or displayed. Further examples include commands sent from the server 120 for performing diagnostic, reboot/restart, patch and upgrade functions on the vehicle content module 102.

The reportable settings monitored and identified by the vehicle content module 102 include one or more of the following parameters, each having a value, being represented by data in specific data fields in the data transmitted on the vehicle data bus 114:
(i) vehicle position parameters, including: a Cell Cellular Tower Position Identifier (Cell ID) and Unique Identifier of a GSM/mobile service provider (e.g. ‘South Melb’ indicates that the vehicle 106 is located in the suburb of South Melbourne, Victoria, Australia); data from an in-vehicle navigation system (e.g. a Navman product); and parameters of a Global Positioning System (GPS) receiver in communication with the vehicle content module 102;
(ii) drive time parameters, including: a start time and location (with a location accuracy that depends on how the position location is determined, e.g. by, Cell ID, GPS latitude and longitude); a stop time and location; a distance and an average vehicle speed; vehicle acceleration and deceleration rates; and vehicle engine revolutions per minute (RPM);
(iii) radio broadcast parameters, including: a radio type (e.g. analogue, digital, DAB, XM, satellite, Internet); a band selection (e.g. AM, FM, software); a frequency selection (e.g. 101.9 MHz); the user's favourite channel presets (e.g. Preset 1=101.9 MHz, Preset 2=89.9 MHz); the user's current volume setting (e.g. 20 dB); an automatic volume adjust level (e.g. automatic volume increases as vehicle speed increases); audio equaliser preferences (e.g. EQ=Rock, Bass=+3, Treble=+6); a station name if available; a program type if available (e.g. Rock, Talkback, Pop); and a radio tuner reception performance parameters (e.g. signal strength, multi-path, stereo, mono);
(iv) Compact Disc (CD) parameters (including where the CD player has an integrated MP3 player), including: an album title if available; an artist name if available; a current song title if available; identifier of current track playing and played/elapsed time, track repeat settings (e.g. the user's favourite song); current volume and equaliser settings; and a standardised music database ID (e.g. iTunes, Gracenote, CDDB);
(v) DVD/video playback parameters, including: a video/movie name if available; rear seat viewing settings; identifier of current video playing and played/elapsed time, front seat viewing settings; and volume and equaliser settings; and a standardised movie identifier (e.g. Internet Movie Database IMDB);
(vi) television broadcast parameters, including: a broadcast type (e.g. analog, digital, DVB, Internet, Satellite); a band selection (e.g. VHF, UHF, DVB, Internet Media Provider); a frequency selection (e.g. Channel 9, Google TV); the user's favourite channel presets (e.g. Preset 1=ABC, Preset 2=GTV9); the user's current volume setting (e.g. 20 dB); the user's current audio equaliser preferences (e.g. EQ=Rock, Bass=+3, Treble=+6); a station name; and current program information (e.g. “Home and Away”);
(vii) mobile/cell telephone call parameters, including: a quantity of calls; a number dialled; a preset number dialled; a successful call record; an engaged call record; a dropped/lost call record; a call duration; a call location; and a call time;
(viii) mobile Internet access parameters, including: a URL of a current site being visited/accessed; an IP Address of the current site being visited; URLs of previous site visited; site authentication and security activation activity; timestamps of Internet activity; and bookmarked site preferences and visit activity;
(ix) voice command and response parameters, including: timestamps of voice command activity; timestamps of voice response activity; voice command user inputs; synthesized voice output activity; invalid voice commands; speech-to-text software data; and text-to-speech software data;
(x) mobile and ultra-mobile personal computing parameters, including: operating system and device specifications; and software application status and activity indicators;
(xi) parameters of external media players integrated and/or interfaced to a factory audio system (e.g. an MP3 player), including: an album title if available; an artist name if available; a current song title if available; track repeat settings (e.g. the user's favourite song); current volume and equaliser settings; and user play list titles and contents;
(xii) games console parameters, including: a console type (e.g. Playstation, Wii, Xbox, Gameboy, Playstation Portable); game title; game volume; game score results, game player names, game rating (e.g. Exempt, Children, General, Parental Guidance, Mature Adult, Moderate Violence);
(xiii) rear seat entertainment parameters equivalent to the parameters listed above for central/general in-vehicle entertainment units (e.g. audio players, video players, game consoles;
(xiv) driver identification parameters relating to the user 118 in the vehicle 106, including: a unique ignition key identification (ID), which is available in vehicles with keys that are individually coded (the radio presets may also be key specific); seat position parameters, which may be memorized by devices such as a central vehicle processor for each driver of the vehicle; the mobile/cellular phone parameters; individual code text message reply parameters (e.g. a text message response may be requested from the telephone of the user via the instrument cluster display); and an individual keypad code (e.g. a keypad could be included to allow the individual to select their assigned button as identification, or the radio preset numbers could be used to enter an individual's code); and a number of occupants in the vehicle 106 (e.g. determined from the seatbelt lock status).

In an alternative configuration of the content control and monitoring system 100, the GPS receiver transmits data to the vehicle content module 102 via a wireless Bluetooth connection, or another wireless connection such as WiFi, or a direct wired connection, rather than via the vehicle data bus 114.

The vehicle position and time parameters are transmitted with every data packet sent from the vehicle content module 102, allowing all other parameters (e.g. media usage, driver behaviour) to be analysed (in the server 120) in relation to the position and time of the vehicle 106.

The radio tuner reception performance parameters can be used to determine the receivable distance of the corresponding radio station and indicate whether the user 118 changed station because of its content or because of a weak/noisy signal reception.

The rear seat entertainment parameters are monitored separately in vehicles which allow source splitting between the front and rear passengers, e.g. where a driver listens to broadcast radio while rear passengers listen to a CD playing from the single dash audio system.

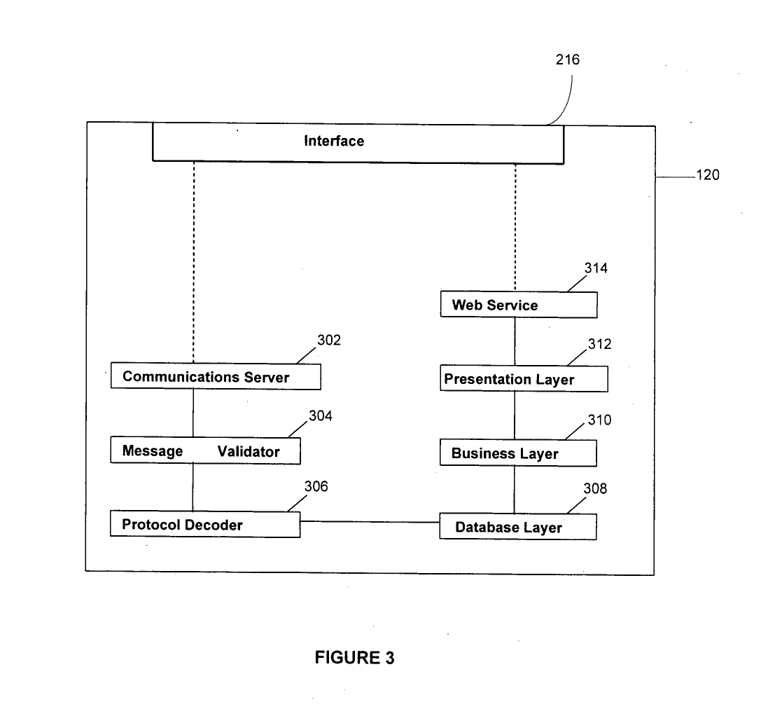

The server 120, as shown in FIG. 3, includes a communications server 302 for establishing and controlling one or more simultaneous communications channels with one or more vehicle content modules 102 (in one or more vehicles 106), and/or one or more other servers 120, via an interface 216. The server also includes a message validator 304 to validate incoming messages (e.g. by performing checks on validation), a protocol decoder 306 for extracting individual messages from received usage data (in the form of data packets) and assembling the usage data into chronological order (by a timestamp from the vehicle content module 102) for addition to the database 130. The protocol decoder 306 also timestamps packets of incoming usage data before arranging them in chronological order. The server 120 includes a database layer 308 (in communication with the database 130) for storing and retrieving data messages, a business layer 310 for analysing the usage data, a presentation layer 312 for providing a user interface reporting data for the one or more reporting devices 132, and a Web service 314 for providing Web-based access to and from the server 120. The database layer 308 generates a database of records, each uniquely indexed, e.g. using a standard GUID (Globally Unique Identifier) format.

The server 120 performs a number of report processes in the form of Media Analysis Functions. The server 120 may display the reports generated by these report processes on a computer terminal attached to the server 120, or via data network connections (e.g. wireless data networks, the Internet, or the Web) on the reporting devices 132. The Media Analysis Functions may be initialised automatically, e.g. based on a timer, or generated in response to a request from one of the reporting devices 132 or an administrator of the server 120. The Media Analysis Functions include multidimensional multivariate statistical data analysis functions and reporting operations on the usage data in the database 130. The Media Analysis Functions perform one or more of the following report processes:
(i) process the usage data to generate report data representing a number of listeners by station/channel frequency; by driver demographic profile; by vehicle position; by media program; and/or by media presenter/s;
(ii) process the usage data to generate report data representing a ratio of entertainment sources, radio, CD, DVD, MP3, phone;
(iii) process the usage data to generate report data representing popular and unpopular music; media programs; media advertisements; media presenter/s; media news breaks; and/or media programming to advertising ratio;
(iv) process the usage data to generate report data representing peak, average, mean, and minimum listening patterns, including details of time, date, day of the week, season, station/channel frequency, location including global position, program, time of day, breakfast period, drive time, media music track, media presenter/s, media advertisement, media news break, major news event, vehicle type, driver pattern, individual driver demographic profile, group driver demographic profile, individual address, sex, age, race, religion, entertainment source, communications source (e.g. mobile phone call), preset, volume, vehicle type, vehicle start time, vehicle stop time, vehicle content module ID (of the vehicle content module 102);
(v) data warehousing and mining operations including measuring, aggregating, counting, sorting, filtering, algorithmically processing, programmatically processing, mathematically processing, randomising, mixing, graphing, charting, data cubing, pivot tabling, grouping, classifying, averaging, meaning, truncating, standard deviating, categorising, indexing, slicing, quantising, profiling, pattern recognising, harmonising, approximating, and/or transforming; and.
(vi) linking time-stamped stored data records within the database 130 to radio logger data that maintains permanent time-stamped recordings (in an electronic file format such as MP3, AVI, MPEG) of all broadcast media so that broadcast media content can be replayed retrospectively for any broadcast station such as radio or TV for any chosen moment in time.

The report data can be selected or combined to provide audience survey data. The audience survey data can represent ratings information for content providers.

The server 120 can be implemented using a computer server produced by IBM Corporation or Apple Inc. running a computer operating system such as Microsoft Windows Server 2000/2003 or Mac OS X. The server 120 can be configured as a plurality of physical servers operating together as a single logical and functional entity. The database 130 can be implemented using a database server such as SQL Server 2000/2005 and can be configured as a single database application or as a distributed and clustered application for the purposes of fault tolerant reliability, scalability and high performance. The components 302 to 314 can then be implemented using computer program code written using and based on a software development architecture, such as the Microsoft .Net Framework. Alternatively dedicated hardware circuits (e.g. ASIC or Field Programmable Gate Arrays) can be used for at least some of the components.

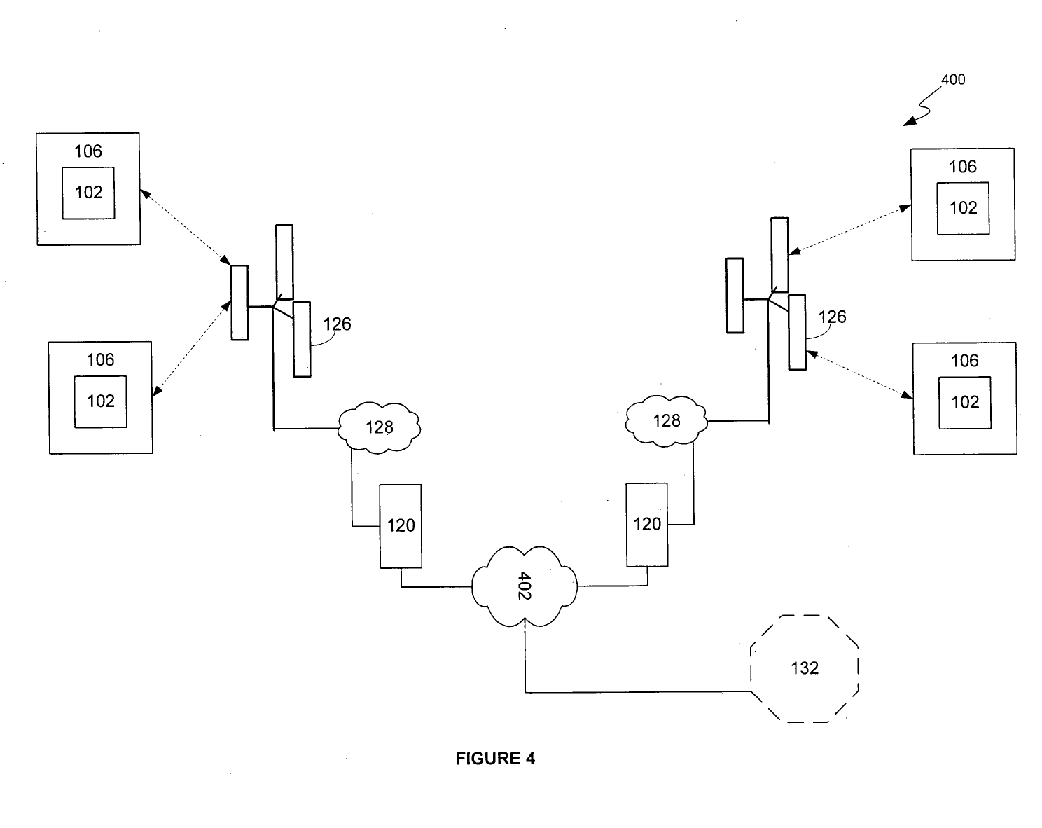

A plurality of content control and monitoring systems 100 may be connected into a multi-vehicle content module system 400 as shown in FIG. 4. The plurality of vehicle content modules 102 (each in a vehicle 106) communicate with a plurality of external wireless transceivers 126, which communicate (e.g. via a data network 128) with a plurality of servers 120, which are in turn connected by a data network 402 (e.g. the Internet) to each other and to the reporting devices 132.

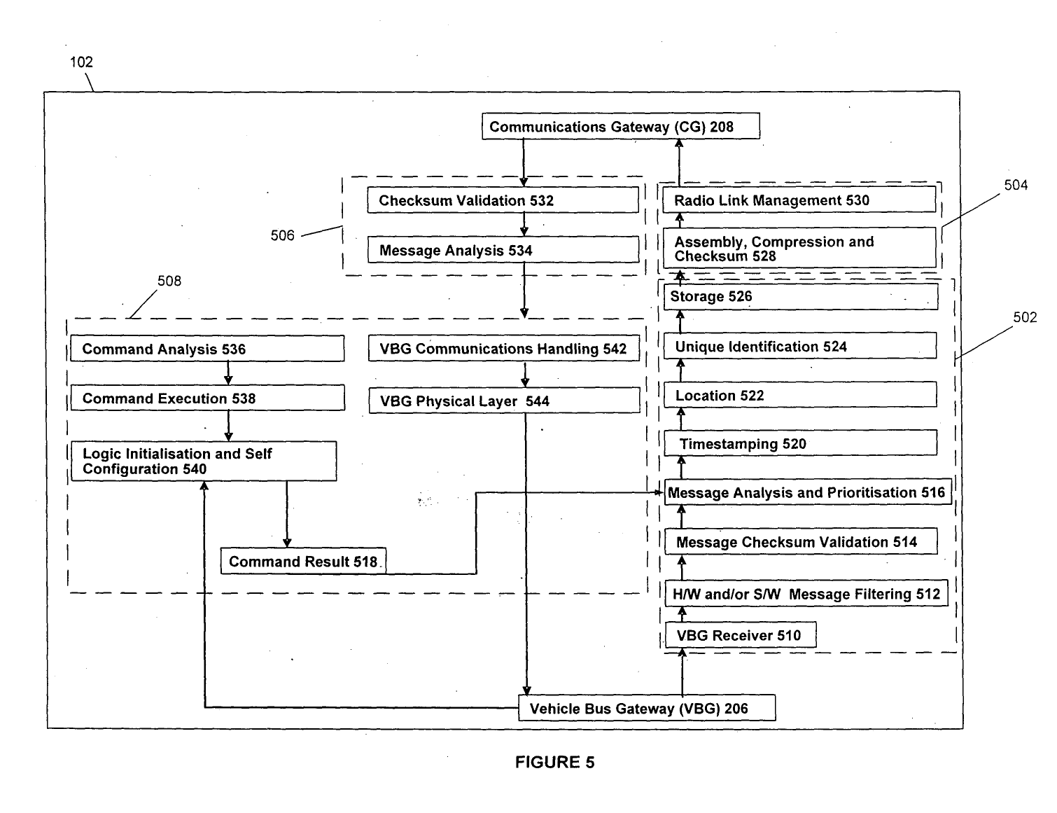

The vehicle content module 102 includes a number of modules as shown in FIG. 5, including a series of monitoring modules 502 and transmission modules 504 for monitoring media usage data and transmitting it to the server 120. The vehicle content module 102 also includes receiving modules 506 and control modules 508 for receiving messages from the server 120 and issuing resultant commands over the vehicle data bus 114 or to other modules in the vehicle content module 102.

The monitoring modules 502 include a VBG receiver 510 which receives all network data transmitted on the vehicle data bus 114 via the vehicle bus gateway (VBG) 206. The VBG receiver 510 sends the received network data in the form of messages to a message filtering module 512. The filtering module 512 inspects and identifies messages from the vehicle bus gateway (VBG) 206 that are relevant to the operation of the vehicle content module 102. The messages are identified based on the parameter data values held in the messages, which includes header data identifying the type of message. The identified messages are selected for further processing by the vehicle content module 102 and the others are discarded. The message filtering module 512 may include software filters and/or hardware/electronic circuit filters. The filtered, i.e. selected, data is transmitted to a message checksum validation module 514 to check that messages in the data are substantially free of errors. Correct (i.e. valid) messages are transmitted to a message analysis and prioritisation module 516 for classifying each received data message into different groups (defined by a Vehicle Information Database which is a communications messaging protocol that determines the interpreted meaning of each message as typically defined by the message headers used by various vehicle manufacturers) depending on their content. For example, the message analysis and prioritisation module 516 separates received data messages into the categories which are being monitored, e.g. radio volume settings. The rules applied by the message analysis and prioritisation module 516 are controlled by a command result module 518 in the control modules 508 portion of the vehicle content module 102. Following analysis and prioritisation, the selected messages are transmitted to a time stamping module 520, a location module 522 and a unique identification module 524 which extract from each message information regarding the time that the message was recorded (by the vehicle content module 102), the location of the vehicle 106 at the time when it was recorded, and the unique vehicle content module ID of the vehicle content module 102 on which it was recorded (i.e. corresponding to a unique vehicle 106). The tagged message data is then transferred to a storage module 526 for storage by the vehicle content module 102. The message is also transmitted to an assembly, compression and checksum module 528 which prepares data packets in an appropriate format for transmission to the server 120. The prepared data is sent to a radio link management module 530 which sends data to the communications gateway 208 which transmits data to the server 120.

The communications gateway 208 is also used to receive data from the server 120. Received data from the communications gateway 208 is received in the vehicle content module 102 by a checksum validation module 532 and in the reception modules 506. Data integrity is maintained through the use of checksum data injected into the data messages by the server 120. If a message coming from the server 120 is found to have a valid checksum, the message is analysed in message analysis module 534 which determines whether the incoming message is related to internal commands for the vehicle content module 102, or alternatively external commands to be directed to the user interfaces 104 on the vehicle data bus 114. For internal messages, the message is transmitted to a command analysis module 536 for classifying depending on which of the available commands the incoming message contains. The message is then sent to an appropriate portion of a command execution module 538 which executes the command. The logic initialisation and self configuration module 540 performs functions including restarting and initialising all software functions of the vehicle content module 102, and initialising the vehicle bus gateway interface 206 for various types of vehicle data bus 114. The result of the logic initialisation and self configuration module 540 is transmitted by the command result module 518 to the message analysis and prioritisation module 516.

If the message from the server 120 is determined to be an external VBG command (i.e. to be directed to the user interfaces 104 on the vehicle data bus 114) in the message analysis module 534, the message data is transmitted to a content command generator in the form of a VBG communications handling module 542 which prepares the message to be transmitted by a VBG physical layer module 544. The VBG physical layer module 544 transmits data onto the vehicle data bus 114 via the vehicle bus gateway 206.

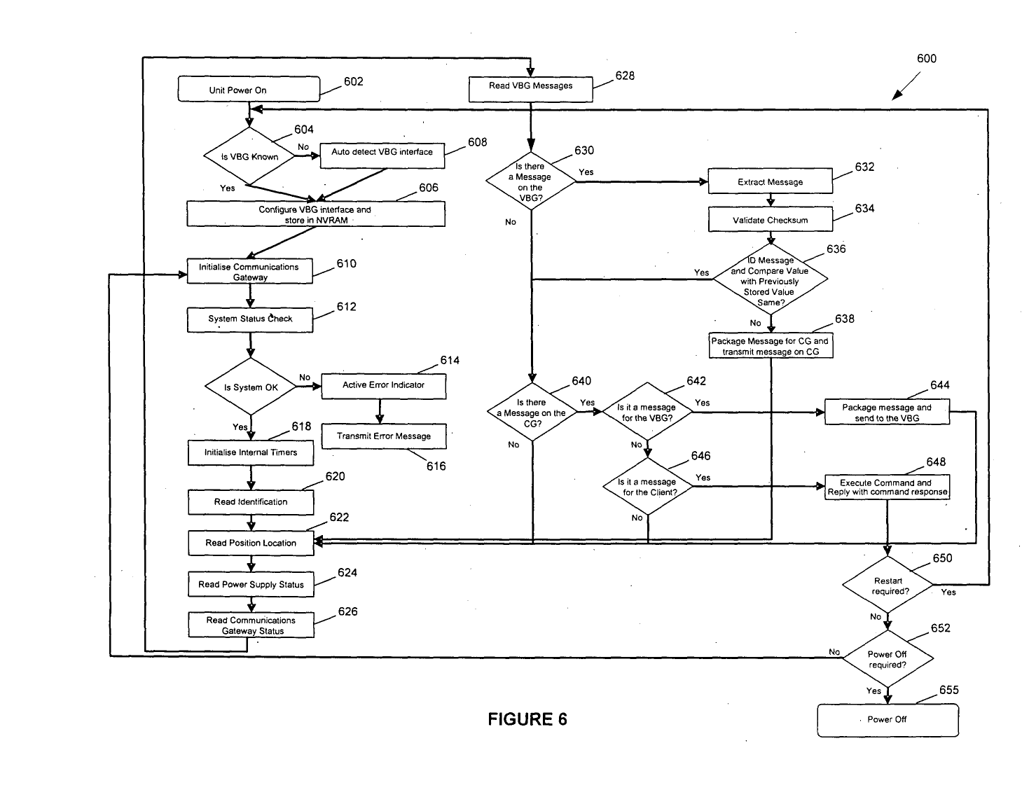

The vehicle content module 102 performs a vehicle control and monitoring process 600, represented in FIG. 6, which commences with a power-on step (602) activated by, for example, the vehicle 106 being turned on. Following power-on 602, the vehicle content module 102 determines (in step 604) whether the vehicle bus gateway (VBG) 206 is already known. If the vehicle bus gateway 206 is known, the vehicle content module 102 configures a vehicle bus gateway interface and stores the corresponding settings in a non-volatile memory. If, on the other hand, the VBG 206 is not known (as tested in step 604) the VBG 206 is auto-detected at step 608 before the configuration step 606. The communications gateway 208 is then initialized in step 610. Thus, both communications gateways 208, 206 are now initialised. The vehicle content module 102 then performs a system status check at step 612: if the system is not ok (i.e. an error is detected), an active error is raised in an active error indicator step 614 and an error message is transmitted over the communications gateway 208 and/or the vehicle bus gateway 206 in a transmit error message step 616. If, on the other hand, the system status check step 612 is successful, the vehicle content module 102 initialises internal timers (in step 618) and reads the unique identification details of this particular vehicle content module 102 (e.g. corresponding to the particular vehicle 106), in step 620. The vehicle content module 102 then enters an operational loop commencing at step 622 by reading the position location of the vehicle 106 in step 622. The operational loop continues by checking the power supply status (step 624) and the status of the communications gateway 208 (step 626) before reading messages from the vehicle data bus 114 using the vehicle bus gateway 206 (in step 628).

If a message is read from the vehicle bus gateway 206 (determined at step 630), the message is extracted (in step 632) and processed by the filter module 512 to determine if it is to be selected and retained for further processing. A filtered message is tested to determine its validity in a validate checksum step 634. Invalid messages are deleted at step 634 while valid messages are tested to determine whether the value in the message has changed since a message relating to the same parameter (e.g. radio volume) has changed since the value was last tested; this requires that the vehicle content module 102 tests the received value in step 636 to a stored value in a variable array (not shown) maintained within the software of the vehicle content module 102. If the message contains a changed parameter value, the new value is stored in software memory and transmitted to the communications gateway 208 in step 638. Following step 638, the vehicle content module 102 returns to the read position location step in 622 in the operational loop.

If no message is found on the vehicle bus gateway 206 (in step 630) or if the parameter value has not changed (in step 636), vehicle content module 102 tests whether there is an incoming message in the communications gateway 208 (i.e. a message from the server 120) in step 640. If a message is found in the communications gateway 208, and it is a message for the vehicle bus gateway 206 (tested at step 642) the message is packaged and sent over the vehicle data bus 114 via the vehicle bus gateway 206 in step 644. The vehicle content module 102 then returns to the read position location step 622 in the operational loop. If the message from the communications gateway 208 is not for the vehicle bus gateway 206, but is a message for the vehicle content module 102 (as tested at step 646), a command is extracted from the message, executed and a reply for the communications gateway 208 is prepared in step 648. Following execution of the command at step 648, the vehicle content module 102 determines whether a restart of the vehicle content module 102 is required at step 650: if a restart is required, the vehicle content module 102 restarts itself and then returns to the step directly following the power-on step 602. If a restart is not required (at step 650) but a power-off is required, as tested at step 652, the vehicle content module 102 will turn itself off in a power-off step 655. If no restart is required (step 650) and no power-off is required (step 652), the control of the unit (following execution of the command extracted from the message) returns to initialisation of the communications gateway at step 610.

To optimise data throughput and transmission costs, the vehicle content module 102 typically only transmits data to the server 120 based on reportable changes in the monitored parameters. Improvements in data throughput are also achieved by compression.

Many modifications will be apparent to those skilled in the art without departing from the scope of the present invention as herein described with reference to the accompanying drawings.

1. A content monitoring system for monitoring the use of a user interface in a vehicle having a data communications network, including:
an interface for communicating with the data communications network; and
a monitoring module for collecting content usage data, associated with use of the user interface, in real time from the data communications network.

2. A content monitoring system as claimed in claim 1, including:
an analysis module for processing collected content usage data received from the vehicle and generating content usage report data, representing one or more usage reports relating to the use of content in the vehicle.

3. A content monitoring system as claimed in claim 2, including:
a transmission module for transmitting the collected usage data from the vehicle; and
a server system, including the analysis module, for receiving the transmitted usage data.

4. A content monitoring system as claimed in claim 3, wherein the analysis module processes collected content usage data from a plurality of vehicles to generate audience survey report data.

5. A content monitoring system as claimed in claim 4, including a presentation system for transmitting the report data to a communications device as content associated with the report data is being used in the vehicles.

6. A content system as claimed in claim 1, including a command generator for generating control data, relating to a command for the user interface, and sending the control data to the data communications network using the interface.

7. A content system as claimed in claim 6, including a server system for generating a command message for sending to the vehicle to generate the control data.

8. A content system as claimed in claim 7, wherein the server system generates the command message to send to the vehicle to provide associated content using the user interface.

9. A content control system as claimed in claim 7, wherein the usage data includes data representing location of the vehicle and the command message is generated based on the location of the vehicle.

10. A content control system as claimed in claim 9, wherein the command message includes data representing marketing content.

11. A vehicle content module for controlling and monitoring a user interface in a vehicle having a data communications network, including:
a gateway interface for communicating with the data communications network; and
a collector for collecting usage data, relating to use of the user interface, in real time from the data communications network, using the gateway interface; and
a command generator for generating control data, relating to a command for the user interface, and sending the control data to the data communications network using the gateway interface.

12. A vehicle content module as claimed in claim 11, wherein the data communications network is based on a communications protocol including one of a CAN, LIN, UART, MOST, TCP, UDP, and IP bus.

13. A vehicle content module as claimed in claim 11, wherein the user interface includes a content player and an input unit associated with the content player.

14. A vehicle content module as claimed in claim 11, wherein the usage data represents use by the content player of one or more content items.

15. A vehicle content module as claimed in claim 14, wherein the usage data includes identification data that at least partially identifies the content items

16. A vehicle content module as claimed in claim 15, wherein the identification data includes frequency channel selection data, time data, and volume level data for said player.

17. A vehicle content module as claimed in claim 14, wherein items include: self-loaded content of at least one of a CD, DVD, an iPod, an MP3 file; and broadcast content, including at least one of an AM radio, FM radio, satellite radio, and TV broadcast.

18. A vehicle content module as claimed in claim 13, wherein player is a radio.

19. A content control and monitoring system for controlling and monitoring a user interface in a vehicle having a data communications network, including:
a server system for generating and sending a control message to a vehicle content module as claimed in claim 11 for controlling the user interface; and
an analysis module for processing the collected usage data received from the vehicle content module, to generate content usage report data, representing one or more usage reports relating to the use of the user interface.

20. A content control and monitoring system as claimed in claim 19, wherein the control message is generated based on the collected usage data.

21. A vehicle module in a vehicle, including:
a gateway interface to a data communication network of the vehicle;
a monitoring module to obtain in real time usage data from the communications network representing use of a user interface of the vehicle; and
a transmission module for transmitting the usage date from the vehicle.

22. A vehicle content module for monitoring the use of a content player in a vehicle, including:
a gateway interface to a data communications network of the vehicle; and
a data collector for monitoring data on the data communications network to access in real time player data representing use of the player.

23. A content monitoring system including:
an analysis module for processing the player data, from a vehicle content module as claimed in claim 22, to generate content usage report data.

24. A content monitoring system as claimed in claim 23, including:
the vehicle content module with a transceiver module for transmitting the player data from the vehicle; and
a server system including the analysis module for receiving the player data.

25. A content monitoring system as claimed in claim 24, wherein the server system, in response to the usage report data, sends command data to said transceiver module to control the player and provide content on the basis of the command data

26. A content usage monitoring process performed on a vehicle, including:
monitoring bus data on a vehicle data bus of the vehicle;
extracting usage data from the bus data relating to content usage in the vehicle; and
storing the usage data with a time stamp.

27. A content usage monitoring process, as claimed in claim 26, including transmitting the usage data from the vehicle, using a wireless communications interface, for real time analysis.
